(19) United States
(12) Patent Application Publication
(10) Pub. No.: US 2011/0082753 A1
(43) Pub. Date: Apr. 7, 2011

(54) METHOD OF GENERATING REVENUE FOR A GOVERNMENTAL ENTITY

(76) Inventor: Chris M. Ohman, Tulsa, OK (US)

(21) Appl. No.: 12/896,702

(22) Filed: Oct. 1, 2010

Related U.S. Application Data
(63) Continuation-in-part of application No. 11/267,552, filed on Nov. 4, 2005.

(51) Int. Cl. G06Q 30/00; G06Q 90/00

(52) U.S. Cl. 705/14.68; 705/14.69; 705/500

(57) ABSTRACT

A method of generating revenue for a governmental entity is achieved by identifying a stationary structure supporting a traffic route information sign on a first side; making provisions for inclusion of commercial advertisement on an unused second side portion of the stationary structure; executing a licensing agreement between an interested party and the governmental entity for use of the unused second side portion of the stationary structure for commercial advertisement, wherein the executed licensing agreement includes an agreed upon royalty payable to the governmental entity; securing a commercial advertisement on the unused second side portion of the stationary structure; and collecting the agreed upon royalty from the interested party to generate revenue for the governmental entity.

### RELATED APPLICATIONS

This application is a continuation-in-part application of co-pending U.S. application Ser. No. 11/267,552 filed Nov. 4, 2005, entitled “Method of Generating Revenue For A Governmental Entity,” which claims priority to U.S. Provisional Application No. 60/625,990 filed Nov. 8, 2004, entitled “Method Of Generating Revenue For A Governmental Entity.”

### BACKGROUND OF THE INVENTION

1. Field of the Invention

The present invention relates to revenue generation for a governmental entity. More particularly, but not by way of limitation, the present invention relates to a commercialization of unused portions of a governmentally controlled stationary structure, such as a highway sign support structure, for use in supporting commercial advertisements.

2. Background of the Invention

Opportunities for governmental agencies to generate revenues, other than through regulatory, processing, and licensing fees or taxation are limited. Often, the ability to increase fees or taxes relies on a statutory mandate and may necessitate voter approval, either of which may prove to be a daunting task.

As governmental costs escalate, pressures continue to be placed on governmental officials to reduce operating costs, while maintaining and improving the level and quality of services provided. As such, challenges remain and a need persists for improvements in techniques and methods for generating revenue streams for governmental entities that are not fee or tax based, and to which the present invention is directed.

### SUMMARY OF THE INVENTION

In accordance with an exemplary embodiment, a method of generating revenue for a governmental entity is claimed. The exemplary method includes: identifying a stationary structure, such as a highway sign support structure used to support a traffic route information sign on a first side; and making a lawful provision for inclusion of commercial advertisement on an unused second side portion of the stationary structure. In an exemplary method the steps further include: executing a licensing agreement between an interested party and the governmental entity for use of the unused second side portion of the stationary structure for commercial advertisement, wherein the executed licensing agreement includes an agreed upon royalty payable to the governmental entity; securing a commercial advertisement on the unused second side portion of the stationary structure; and collecting the agreed upon royalty from the interested party to generate revenue for the governmental entity. Further exemplary embodiment method step includes securing a commercial advertisement includes a step of securing an electronic billboard to the stationary structure. An exemplary method step includes displaying a non-commercial message on the electronic billboard.

An exemplary embodiment includes at least a step of determining a static or dynamic load bearing ability, or both, of a support post, a truss, or a support post and truss combination supporting the traffic route information sign for use in deciding whether the commercial advertisement may be secured to the stationary structure.

These and various other features and advantages which characterize the claimed invention will be apparent from reading the following detailed description and a review of the associated drawings.

### BRIEF DESCRIPTION OF THE DRAWINGS

FIG. 1 shows a perspective, elevational view of a stationary structure of a type incorporated by the present invention.

FIG. 2 provides a perspective, elevational view of an embodiment of the present invention.

FIG. 3 is a flow diagram of a method of practicing an embodiment of the present invention.

FIGS. 4A-E illustrate a plan view for exemplary embodiments of the present invention.

FIGS. 5A-B portray various exemplary embodiments of the commercial advertisement sign in close up.

FIG. 6 is a flow diagram of a method of practicing an embodiment of the present invention by displacing commercial advertisement and non-commercial message.

### DESCRIPTION OF THE EXEMPLARY EMBODIMENTS

Before explaining the present invention in detail, it is important to understand that the invention is not limited in its application to the details of the construction illustrated, or by the steps of construction inherently present by way of illustration of the appended drawings. The invention is capable of other embodiments and of being practiced or carried out in a variety of ways. It is to be understood that the phraseology and terminology employed herein is for the purpose of description and does not impose limitation on the present invention.

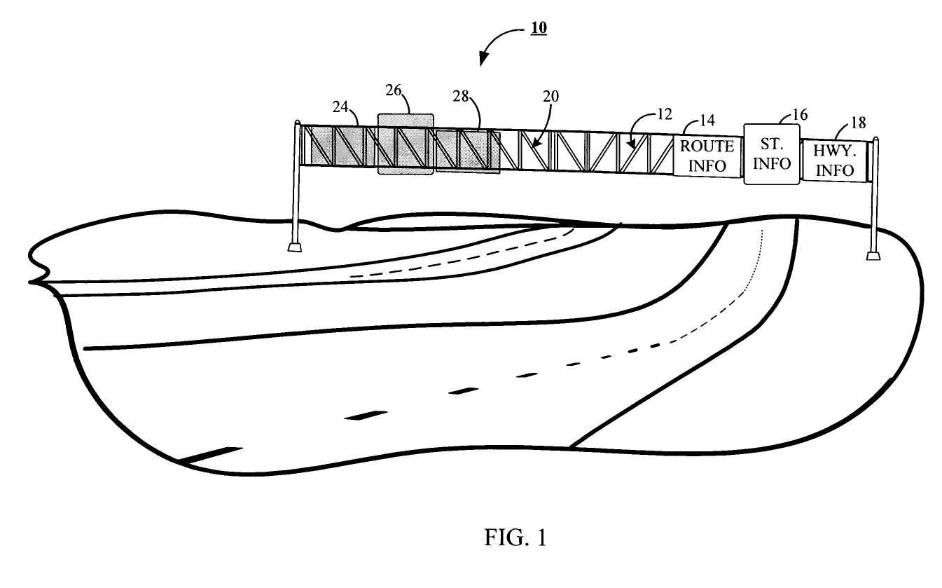

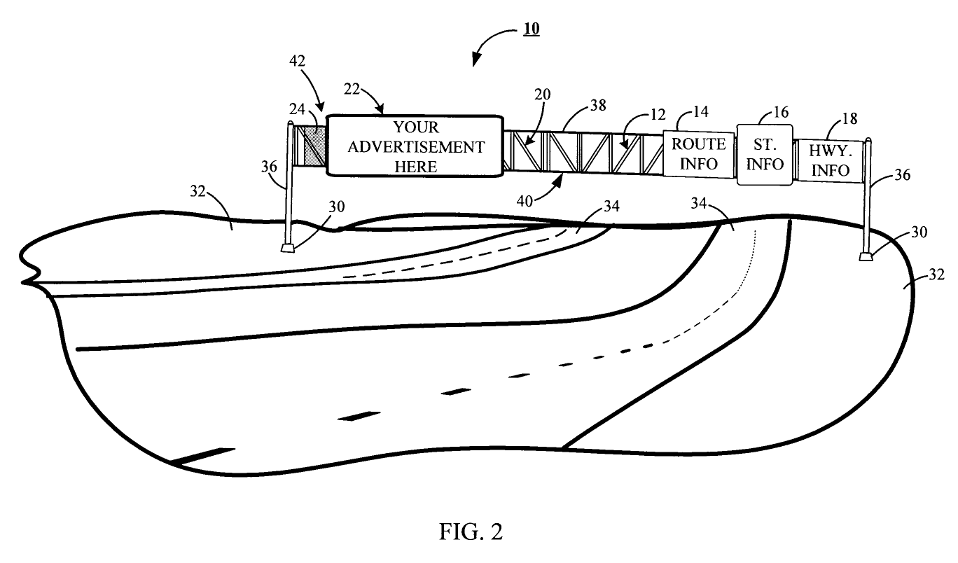

Referring now to the drawings, wherein like reference numerals indicate the same parts throughout the several views, a stationary support structure, such as a traffic sign support structure 10 (also referred to herein as stationary structure 10), shown by FIG. 1, provides a host structure for practicing the present invention. Frequently, traffic route information signs provide motorists with information regarding upcoming traffic routes. In exemplary embodiments, the stationary structure 10 may be a bridge, overpass, overpass, or other suitable stationary structure. In an exemplary embodiment, the stationary structure 10 includes: at least a first side portion 12 for use in supporting traffic route information sign 14, and may support additional traffic route information signs such as 16, and 18; and at least a second side portion 20 for use in supporting a commercial advertisement sign 22, as shown by FIG. 2. The commercial advertisement sign 22 can be characterized as a traditional poster billboard; or, newer technologies, referred to as an electronic billboard (EBB), commercial electronic variable message sign (CEVMS), digital billboard (DBB), etc., may be employed as the commercial advertisement sign.

In an exemplary embodiment, the commercial advertisement sign 22 of FIG. 2 is depicted as a structural member communicating with the stationary structure 10. In an alternate exemplary embodiment, a commercial advertisement is applied to a back side of traffic route information sign 24, and may be applied to a back side of traffic route information signs 26 and 28 as shown by FIG. 1.

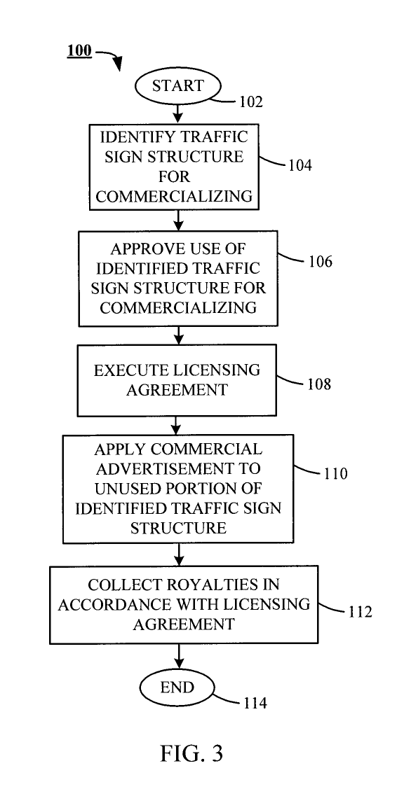

FIG. 3 shows a flow chart 100 of steps included within a method of practicing an exemplary embodiment of the present invention. The exemplary method commences at start process step 102, and continues at process step 104. At process step 104, an authorized governmental entity identifies for commercialization a stationary structure, such as a highway sign support structure (such as 10) used to support traffic route information signs (such as 14, 16, and 18) on a first side portion (such as 12). In other words, exemplary process step 104 involves identifying a stationary structure supporting a traffic route information sign on a first side. At process step 106, the authorized governmental entity assures that statutory or regulatory provisions are made for inclusion of commercial advertisement on an unused second side portion (such as 20) of the stationary structure (such as 10). That is process exemplary step 106 entails making a lawful provision for inclusion of commercial advertisement on an unused second side portion of the stationary structure, wherein the lawful provision is selected from a group consisting of a regulatory provision and a statutory provision.

As used herein and as understood by one skilled in the art, statutory and regulatory provisions are lawful provisions. The Highway Beautification Act of 1965 outlined control of outdoor advertising along the Interstate Highway System and the existing Federal-aid primary roadway system. Over time, most States have evolved a body of legislation and regulations to control off-premise outdoor advertising (often known as billboards), and many local governments have developed similar rules.

The Federal Highway Administration of the U.S. Department of Transportation publishes a Manual on Uniform Traffic Control Devices (MUTCD) under 23 Code of Federal Regulations (CFR), Part 655, Subpart F. The MUTCD defines the standards used by road managers nationwide to install and maintain traffic control devices on all public streets, highways, bikeways, and private roads open to public traffic in the United States. All States must adopt the 2009 National MUTCD as their legal State standard for traffic control devices within two years.

The skilled artisan will understand government authorities, namely regulatory agencies, such as the U.S. Department of Transportation, make regulatory provisions and legislative bodies, such as the Oklahoma City Council, make statutory provisions; making regulatory or statutory provisions is making lawful provisions; and such lawful provisions must be made before inclusion of commercial advertisement on an unused second side portion of a stationary structure supporting traffic route information on a first side portion. It will be further understood by one skilled in the art that complying with lawful provisions can only occur after government authorities have made regulatory or statutory provisions; and making lawful provisions is different and distinct from complying with lawful provisions.

Continuing through the exemplary method depicted in FIG. 3 at process step 108, with the proper authorization in place, the governmental entity enters into negotiations leading to an executed licensing agreement between an interested party and the governmental entity for the use by the interested party of the unused portion of the stationary structure (such as 10) for support of a commercial advertisement sign (such as 22), in exchange for royalty payments from the interested party. That is exemplary process step 108 involves executing a licensing agreement between an interested party and the governmental entity for use of the unused second side portion of the stationary structure for commercial advertisement, wherein the executed licensing agreement includes an agreed upon royalty payable to the governmental entity.

A skilled artisan will understand that a licensing agreement is an agreement whereby the licensor confers a privilege to the licensee to occupy the property under the licensor only so far as necessary to engage in the agreed acts or the performance of agreed services; the licensing agreement may be valid although only orally agreed to; and the licensing agreement is revocable by the licensor. Whereas, the skilled artisan will understand that a leasing agreement is an agreement whereby the lessor relinquishes his right to immediate possession of property while retaining the future interest in the property and ultimate legal title, and the lessee acquires exclusive possession of the property against all the world for all purposes not prohibited by the leasing agreement terms; the leasing agreement must ordinarily be in writing under the Statute of Frauds; and the leasing agreement is irrevocable during its term. One skilled in the art will further understand that the licensing agreement and the leasing agreement are not the same agreement, and the licensing agreement is not an obvious substitute for the leasing agreement.

Returning to the exemplary method in FIG. 3 at process step 110, the commercial advertisement is applied to the unused portion of the stationary structure (such as 10). Which means that exemplary process step 110 entails securing a commercial advertisement on the unused second side portion of the stationary structure.

At process step 112 of the exemplary method, royalty payments are collected by the governmental entity. That is process step 112 involves collecting the agreed upon royalty from the interested party to generate revenue for the governmental entity. The method shown by flow chart 100 concludes at end process step 114.

Returning to FIG. 2, shown in an exemplary embodiment therein is a stationary support 30, anchored to the ground 32. In another exemplary embodiment, the stationary support 30 is formed from concrete, or other suitable construction material that can be envisioned by one skilled in the art, and is located a predetermined distance from a thoroughfare 34. In an alternative exemplary embodiment, a support post 36 is secured to the stationary support 30, and is configured to maintain traffic route information signs, such as 14, 16, and 18, a predetermined distance above the ground 32. In an exemplary embodiment, a truss 38 is secured to the support post 36, and is configured to support the traffic route information signs 14, 16, and 18 on a first side 40, and the traffic route information sign 24 on a second side 42. The truss 38 is further configured to support the traffic route information signs 14, 16, 18, and 24 at the predetermined distance above the ground 32. The stationary support 30, the support post 36, and the truss 38 collectively form the stationary structure 10.

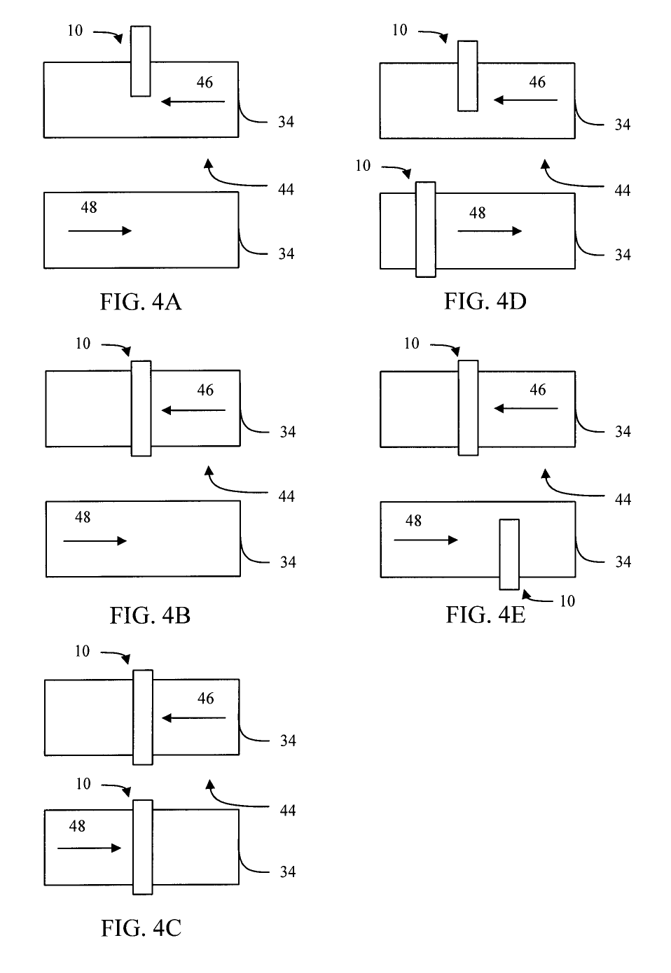

FIG. 4 portrays other exemplary embodiments in plan view. In exemplary embodiments, the stationary structure 10 may span all (such as in FIG. 4A) or part (such as in FIG. 4B) of the thoroughfare 34. Still other exemplary embodiments include, at least, one stationary structure 10 adjacent (such as in FIG. 4C) to another stationary structure 10, or one stationary structure 10 offset (such as in FIGS. 4D and 4E) from another stationary structure 10. Various combinations of placement of the stationary structure 10 relative to the thoroughfare 34 are possible. A skilled artisan will select a predetermined distance 44 between the directions (as shown by arrows 46, 48) on the thoroughfare 34 for achieving objectives of the thoroughfare. The thoroughfare 34 will include, at least, one lane for vehicle traffic.

Revisiting FIG. 3, an exemplary embodiment involves the step of identifying a stationary structure 10 includes, at least, a step of determining a static or dynamic load bearing ability, or both, of the support post 36, the truss 38, or the support post 36 and truss 38 combination supporting the traffic route information sign (such as 14, 16, 18, 24, 26, and 28) for use in deciding whether the commercial advertisement may be secured to the stationary structure. An exemplary embodiment for the step of securing a commercial advertisement includes, at least, a step of securing a commercial electronic variable message sign 22 to the stationary structure 10 when the static or dynamic load bearing ability, or both, of the support post 36 and truss 38 combination is capable of safely supporting the commercial electronic variable message sign. Another exemplary embodiment of the step of securing a commercial advertisement includes, at least, a step of displaying the commercial advertisement on the commercial electronic variable message sign 22.

A skilled artisan will understand that all structural systems have an inherent static loading bearing ability and an inherent dynamic load bearing ability. One skilled in the art will further understand how to calculate a static or dynamic load bearing ability, or both, for a structural system. Furthermore, securing a sign to the structural system would transform the structural system to a different state by transforming the static or dynamic ultimate load bearing abilities of the structural system.

FIG. 2 shows another exemplary method of generating revenue for a governmental entity by steps comprising: anchoring a stationary support 30 to earth (such as 32); sizing a support post 36 and truss 38 combination to accommodate a traffic route information sign (such as 14, 16, and 18) on a first side 40 of the truss and an electronic billboard 22 on a second side 42 of the truss; securing the support post 36 and truss 38 combination to the stationary support 30, in which the stationary support together with the support post 36 and truss 38 combination form the stationary structure 10; making a lawful provision for inclusion of commercial advertisement on an unused second side portion 20 of the stationary structure 10, wherein the lawful provision is selected from a group consisting of a regulatory provision and a statutory provision; executing a licensing agreement between an interested party and the governmental entity for use of the second side 42 of the truss 38, wherein the executed licensing agreement includes an agreed upon royalty payable to the governmental entity; securing the traffic route information sign (such as 14, 16, and 18) to the first side 40 of the truss 38; attaching the electronic billboard 22 on the second side 42 of the truss 38; applying a commercial advertisement to the electronic billboard 22; and collecting the agreed upon royalty from the interested party to generate revenue for the governmental entity.

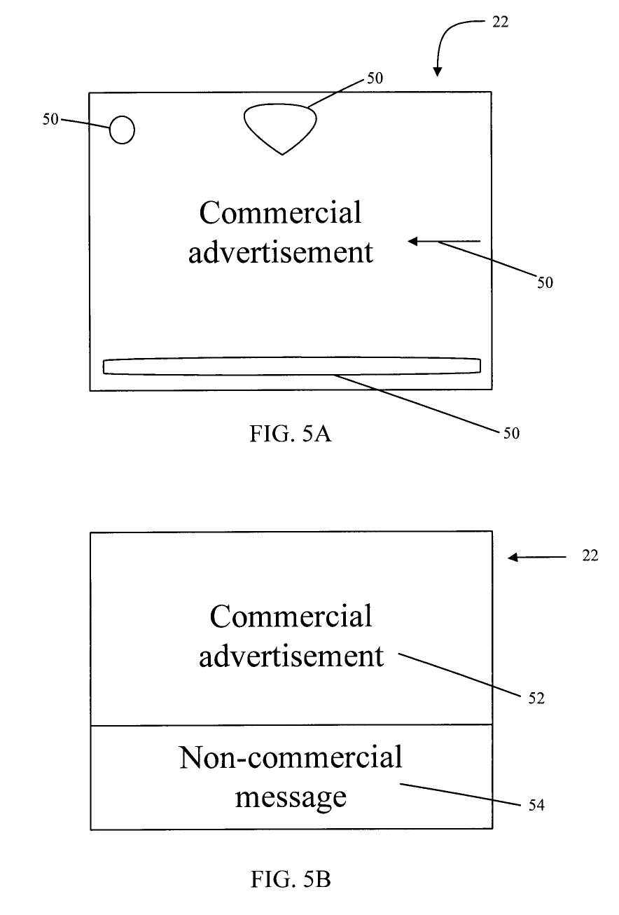

An alternative exemplary revenue generation method comprises: displaying the commercial advertisement on the electronic billboard 22; and applying indicia 50 for identification of said commercial advertisement. Exemplary indicia may be lights, designs, or other eye-catching embodiments that do not compete with traffic information and do not disrupt traffic, as shown in FIG. 5A. In the exemplary embodiments, the indicia 50 may be flashing lights or images, which operate at all times, responsive to traffic (such as vehicle, foot, etc.), or other stimulus. Various colors may be used for the indicia 50, such as blue, red, yellow, or other suitable color, or combination of colors. For example, even someone who is colorblind often notices the color blue, thus blue may be an effective color for the indicia 50.

In another exemplary revenue generation method the traffic route information sign (such as 14, 16, and 18) provides a front side and a back side, and by steps further comprising: displaying traffic route information on the front side of the traffic route information sign; and displaying a second commercial advertisement on the back side of the traffic route information sign.

Other exemplary revenue generation methods include the step of sizing a support post 36 and truss 38 combination includes, at least, a step of determining a static or dynamic load bearing ability of the support post 36 and truss 38 combination for use in deciding whether the electronic billboard 22 may be attached to the second side 42 of said truss 38. Still other exemplary revenue generation methods include, at least, the electronic billboard 22 is attached to the second side 42 of the truss 38 when said static or dynamic load bearing ability of the support post 36 and truss 38 combination is capable of safely supporting the electronic billboard 22.

Another exemplary revenue generation method includes, at least, the commercial advertisement is characterized as a first advertisement, and steps further comprising: applying a second commercial advertisement, which is characterized as a second advertisement, to the electronic billboard 22; metering display of the first advertisement for a first impression duration; and metering display of the second advertisement for a second impression duration. The frequency of display can be modulated. The first and second advertisements may present different commercial concepts, or may present parts of a multipart commercial message displayed during different impressions. Metering is used to determine royalty payment. For example, each commercial advertisement impression, also known as a “hit,” may require a royalty payment.

An alternative revenue generation method includes the step of metering display of the first advertisement includes, at least, a step of adjusting the first impression duration responsive to traffic flow, and the step of metering display of the second advertisement includes, at least, a step of adjusting said second impression duration responsive to traffic flow. For example, the first and second impression durations may be configured for optimum viewing duration from vehicles depending on speed of the traffic, i.e., the speed of vehicle traffic flow. The impression duration can be reduced or prolonged, as needed, for optimal commercial advertisement or other message delivery to a person in the vehicle. In exemplary embodiments, typical impression duration may range from 3 seconds to 15 seconds, but other suitable impression durations may be used.

Still another exemplary revenue generation method includes the step of collecting the agreed upon royalty further includes, at least, a step of calculating for a billing cycle a first total time of the first impression duration and a second total time of the second impression duration. For example, the first impression is displayed in an exemplary embodiment for 5 seconds per display, for 4 displays per minute, at 60 minutes per hour, at 24 hours per day, at 7 days per week, and over 4 weeks per billing cycle for first total time of the first impression of 806,400 seconds for the billing cycle. An invoice, or other suitable billing system, generates a bill or collects the royalty based on the total time. In an alternative embodiment, display has different value at different times of the day that depends on traffic volume, which is either based on historical information, real time traffic volume information, or some combination. For example, display during “rush hour” may require a higher royalty than display during the middle of the night when there is less traffic. In a further embodiment, the licensee selects display of commercial advertisement at a particular time of the day, e.g., a breakfast diner advertises in the morning, a nightclub advertises at night, or a retailer advertises during a sale.

Another exemplary revenue generation method includes, at least, displaying the commercial advertisement responsive to a vehicle adjacent the electronic billboard 22 with preselected content present in the commercial advertisement. For example, the preselected content may be chosen from gas, food, lodging, tourism, or other recognized content category. In an alternative embodiment, the preselected content is more specific, such as GasBrand for gas, RestaurantBrand for food, LodgingBrand for lodging, etc. In an exemplary embodiment, a user in the vehicle communicates preselected preferences to a network that communicates with the electronic billboard 22. Satellite radio, cell phones, smart phone devices such as the Apple iPhone®, personal computers and other suitable devices can be used to communicate with the network. For instance, one can readily envision an iPhone® application to preselect content. In addition, further information can be provided to the user through in car electronics or cell phone using the telephone carrier, or other suitable network. For example, a turnpike pass type device can be envisioned for preselecting content. Of course, the user may elect to not participate in the preselected content system by not preselecting any content.

An exemplary revenue generation method includes displaying the commercial advertisement responsive to a preselected type of vehicle adjacent the electronic billboard 22. For example, a truck stop commercial advertisement could be responsive to a truck approaching the stationary structure. Height, length, width, weight, and axles, among other features, can be used to detect vehicles by motion sensors, scales, etc. In another embodiment, the vehicle contains electronics that send signals, e.g., wirelessly, that identifies the vehicle to the electronic billboard 22, much as a computer peripheral identifies itself to a personal computer.

An alternative revenue generation method includes, at least, sensing vehicle traffic by a vehicle traffic sensor that communicates with the electronic billboard 22; and displaying the commercial advertisement when the traffic sensor senses vehicle traffic. For example, the electronic billboard 22 is located in an area with no appreciable foot traffic so the electronic billboard 22 conserves energy by only displaying the commercial advertisement when vehicle traffic is present. Alternately, an exemplary embodiment located where there is a variety of traffic, e.g., foot, bicycle, vehicle, etc., may display the commercial advertisement when a preselected category of traffic is present to view the commercial advertisement. In various embodiments, an energy source for the electronic billboard may be mains, battery, solar, etc.

An exemplary revenue generation method includes, at least, the lawful provision is characterized as a first lawful provision, and there are exemplary steps further comprising: making a second lawful provision for inclusion of non-commercial message on the unused second side portion 20 of the stationary structure 10, wherein the second lawful provision is selected from a group consisting of a regulatory provision and a statutory provision; and applying a non-commercial message to the electronic billboard 22. Exemplary non-commercial message may be traffic condition update, e.g., closed road, accident delaying traffic, etc. for traffic management. Vehicles could be requested to pull off of the road, e.g., a bridge is out or an emergency vehicle needs clear passage. An alternative exemplary non-commercial message is AMBER® Alert, America's Missing: Broadcast Emergency Response operated by the U.S Department of Justice. The non-commercial message of AMBER® alert provides up-to-date picture and vital data (name, date missing, age, height, weight, etc.) that may be quickly updated to improve the likelihood of finding America's Missing.

An exemplary revenue generation method includes, at least, a step of displaying both the commercial advertisement and the non-commercial message simultaneously. For example, the commercial advertisement is configured to display on a first portion 52 of the electronic billboard 22 and the non-commercial message is configured to display on a second portion 54 of the electronic billboard 22, as seen in FIG. 5B.

An alternative exemplary revenue generation method includes a step of displaying an image chosen from the group consisting of the commercial advertisement and the non-commercial message. For example, the commercial advertisement could be for LodgingBrand and the non-commercial message could be a traffic management message. This exemplary embodiment includes at least one commercial advertisement and at least one non-commercial message.

Still another revenue generation method includes, at least, the step of displaying an image includes a step of selecting the image by an authorized entity based on emergency and public safety criteria. For example, State highway patrol, local police, sheriff, or other public entity, or even private entity may be authorized to set the priority for displaying the image, or what image is to be displayed. In an exemplary embodiment, a new AMBER® Alert is immediately displayed for a selected duration different than any other commercial advertisement or non-commercial message.

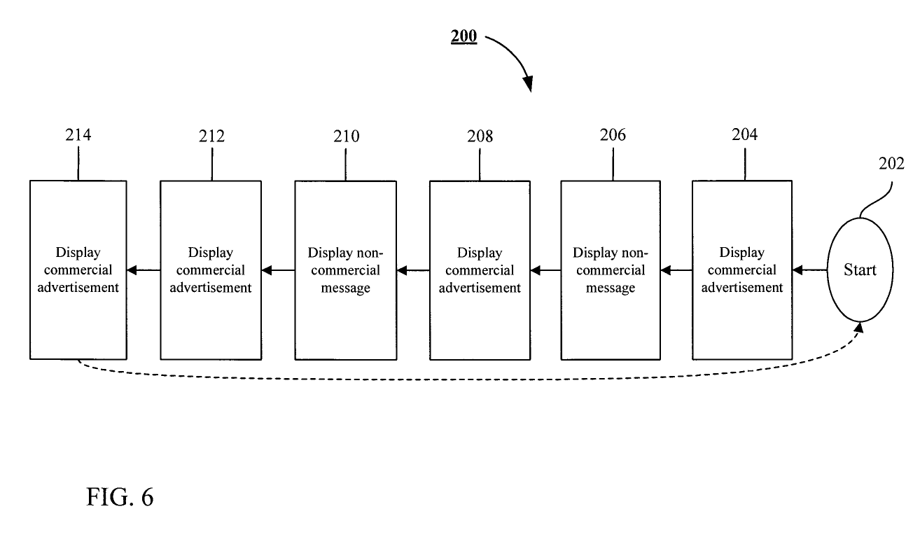

FIG. 6 shows a flow chart 200 of steps for displaying commercial advertisement and non-commercial messages included within a method of practicing an exemplary embodiment of the present invention. The exemplary method commences at start process step 202, and continues at process step 204. At process step 204, a food commercial advertisement is displayed. At process step 206, a non-commercial message regarding traffic management is displayed. At process step 208, a gas commercial advertisement is displayed. At process step 210, a non-commercial message of AMBER® alert is displayed. At process step 212, a lodging commercial advertisement is displayed. At process step 214, another commercial advertisement or non-commercial message is displayed. Any process step or steps may be repeated or skipped or reordered, as needed. The impression duration may be the same or different for each commercial advertisement or non-commercial message that is displayed.

As will be apparent to those skilled in the art, a number of modifications could be made to the exemplary embodiments that would not depart from the spirit or the scope of the present invention. While the presently exemplary embodiments have been described for purposes of this disclosure, numerous changes and modifications will be apparent to those skilled in the art. Such changes and modifications are encompassed within the spirit of this invention.

What is claimed is:

1. A method of generating revenue for a governmental entity by steps comprising:
identifying a stationary structure supporting a traffic route information sign on a first side portion of the stationary structure;
making a lawful provision for inclusion of commercial advertisement on an unused second side portion of the stationary structure, wherein the lawful provision is selected from a group consisting of a regulatory provision and a statutory provision;
executing a licensing agreement between an interested party and the governmental entity for use of the unused second side portion of the stationary structure for commercial advertisement, wherein the executed licensing agreement includes an agreed upon royalty payable to the governmental entity;
securing a commercial advertisement on the unused second side portion of the stationary structure to transform the stationary structure from said stationary structure supporting said traffic route information sign on said first side portion of the stationary structure to said stationary structure supporting said traffic route information sign on said first side portion of the stationary structure and said commercial advertisement on said second side portion of the stationary structure; and
collecting the agreed upon royalty from the interested party to generate revenue for the governmental entity.

2. The revenue generation method of claim 1, in which said support structure includes at least a support post and truss combination supporting said traffic route information sign, and wherein the step of identifying a stationary structure includes a step of determining a static load bearing ability of said support post and truss combination supporting said traffic route information sign for use in deciding whether said commercial advertisement may be secured to said stationary structure, and the step of securing a commercial advertisement includes a step of securing a commercial electronic variable message sign to said stationary structure when the static load bearing ability of the support post and truss combination is capable of safely concurrently supporting said traffic route information sign and said commercial electronic variable message sign.

3. The revenue generation method of claim 1, in which said support structure includes at least a support post and truss combination supporting said traffic route information sign, and wherein the step of identifying a stationary structure includes a step of determining a dynamic load bearing ability of said support post and truss combination supporting said traffic route information sign for use in deciding whether said commercial advertisement may be secured to said stationary structure, and the step of securing a commercial advertisement includes a step of securing a commercial electronic variable message sign to said stationary structure when the dynamic load bearing ability of the support post and truss combination is capable of safely concurrently supporting said traffic route information sign and said commercial electronic variable message sign.

4. The revenue generation method of claim 2, in which the step of securing a commercial advertisement includes a step of displaying said commercial advertisement on said commercial electronic variable message sign.

5. The revenue generation method of claim 3, in which the step of securing a commercial advertisement includes a step of displaying said commercial advertisement on said commercial electronic variable message sign.

6. A method of generating revenue for a governmental entity by steps comprising:
anchoring a stationary support to earth;
sizing a support post and truss combination to accommodate a traffic route information sign on a first side of the truss and an electronic billboard on a second side of the truss;
securing the support post and truss combination to the stationary support, in which the stationary support together with the support post and truss combination form the stationary structure;
making a lawful provision for inclusion of commercial advertisement on an unused second side portion of the stationary structure, wherein the lawful provision is selected from a group consisting of a regulatory provision and a statutory provision;
executing a licensing agreement between an interested party and the governmental entity for use of the second side of the truss, wherein the executed licensing agreement includes an agreed upon royalty payable to the governmental entity;
securing the traffic route information sign to the first side of the truss;
attaching the electronic billboard on the second side of the truss;
applying a commercial advertisement to the electronic billboard; and
collecting the agreed upon royalty from the interested party to generate revenue for the governmental entity.

7. The revenue generation method of claim 6, by steps further comprising:
displaying said commercial advertisement on said electronic billboard; and
applying indicia for identification of said commercial advertisement.

8. The revenue generation method of claim 6, in which said traffic route information sign provides a front side and a back side, and by steps further comprising:
displaying traffic route information on the front side of said traffic route information sign; and
displaying a second commercial advertisement on the back side of said traffic route information sign.

9. The revenue generation method of claim 6, in which the step of sizing a support post and truss combination includes a step of determining a static load bearing ability of said support post and truss combination for use in deciding whether said electronic billboard may be attached to said second side of said truss.

10. The revenue generation method of claim 6, in which the step of sizing a support post and truss combination includes a step of determining a dynamic load bearing ability of said support post and truss combination for use in deciding whether said electronic billboard may be attached to said second side of said truss.

11. The revenue generation method of claim 9, in which said electronic billboard is attached to said second side of said truss when said static load bearing ability of said support post and truss combination is capable of safely supporting said electronic billboard.

12. The revenue generation method of claim 10, in which said electronic billboard is attached to said second side of said truss when said dynamic load bearing ability of said support post and truss combination is capable of safely supporting said electronic billboard.

13. The revenue generation method of claim 6, in which said commercial advertisement is characterized as a first advertisement, and by steps further comprising:
applying a second commercial advertisement, which is characterized as a second advertisement, to said electronic billboard;
metering display of the first advertisement for a first impression duration; and
metering display of the second advertisement for a second impression duration.

14. The revenue generation method of claim 13, in which the step of metering display of the first advertisement includes a step of adjusting said first impression duration responsive to traffic flow, and the step of metering display of the second advertisement includes a step of adjusting said second impression duration responsive to traffic flow.

15. The revenue generation method of claim 13, in which the step of collecting the agreed upon royalty further includes a step of calculating for a billing cycle a first total time of said first impression duration and a second total time of said second impression duration.

16. The revenue generation method of claim 6, by steps further comprising:
displaying said commercial advertisement responsive to a vehicle adjacent said electronic billboard with preselected content present in said commercial advertisement.

17. The revenue generation method of claim 6, by steps further comprising:
sensing vehicle traffic by a vehicle traffic sensor that communicates with said electronic billboard; and
displaying said commercial advertisement when the traffic sensor senses vehicle traffic.

18. The revenue generation method of claim 6, in which said lawful provision is characterized as a first lawful provision, and by steps further comprising:
making a second lawful provision for inclusion of non-commercial message on said unused second side portion of said stationary structure, wherein the second lawful provision is selected from a group consisting of a regulatory provision and a statutory provision; and
applying a non-commercial message to said electronic billboard.

19. The revenue generation method of claim 18, further includes a step of displaying both said commercial advertisement and said non-commercial message simultaneously.

20. The revenue generation method of claim 18, further includes a step of displaying an image chosen from the group consisting of said commercial advertisement and said non-commercial message, in which the step of displaying an image includes a step of selecting the image by an authorized entity based on emergency and public safety criteria.
